(19) United States
(12) Patent Application Publication
(10) Pub. No.: US 2005/0266884 A1
(43) Pub. Date: Dec. 1, 2005

(54) Methods and systems for conducting remote communications

(75) Inventors: Mark J. Marriott, Manhattan Beach, CA (US); Reza Behravanfar, Huntington Beach, CA (US); Mustafa Seifi, Irvine, CA (US); Kumar Swamy, San Diego, CA (US); Ken Beckett, Foothill Ranch, CA (US)

Correspondence Address: EDWARDS & ANGELL, LLP, P.O. BOX 55874, BOSTON, MA, 02205, US

(73) Assignee: Voice Genesis, Inc., Manhattan Beach, CA (US)

(21) Appl. No.: 11/105,817

(22) Filed: Apr. 13, 2005

Related U.S. Application Data
(63) Continuation-in-part of application No. 10/830,611, filed on Apr. 22, 2004.
(60) Provisional application No. 60/464,436, filed on Apr. 22, 2003.

(51) Int. Cl. H04B 1/38

(52) U.S. Cl. 455/558

(57) ABSTRACT

A mobile communications device for communicating with a server over a network, including a visual interface device that displays data, an audio interface device that receives acoustic input and converts the acoustic input to data, a network connection, a memory containing an applications program, and a processor operably coupled to the visual interface device, the audio interface device, and the memory, wherein the applications program is executed on the processor. The applications program locally generates graphical user interfaces with the visual interface and controls the input of data via the audio interface and the transmission of such data over the network to the server such that the data are accessible to a recipient. The applications program also controls the retrieval of electronic messages from a server. In a particular embodiment, the mobile communications device further includes a tactile interface device for navigating data, the tactile interface device operably coupled to the processor.

### CROSS-REFERENCE TO RELATED APPLICATION

This application is a continuation-in-part of U.S. patent application Ser. No. 10/830,611 filed Apr. 22, 2004, which application claims the benefit of U.S. Provisional 60/464,436 filed Apr. 22, 2003.

### BACKGROUND OF THE INVENTION

1. Field of the Invention

The present invention relates generally to mobile communications devices and related software, and more particularly to mobile phones and handheld computers and associated messaging software therefor.

2. Background of the Related Art

Presently, the electronics industry provides a variety of mobile communications devices. These devices include laptop computers, cellular telephones, handheld computers/personal digital assistants (PDA) such as the Zire™ 72 handheld computer available from palmOne, Inc. of Milpitas, Calif., and smart phones which are PDAs with built in phones or phones with built in PDAs such as the Palm Treo™ 650 smartphone available from palmOne, Inc. or the BlackBerry 7250™ smartphone available from Research In Motion of Ontario, Canada, to name some of the most common. In all cases, industry has sought to reduce the size and weight of the devices in order to facilitate mobility, while at the same time maintaining or increasing functionality and communication speed. These efforts have only increased as the market for communications products has grown, a trend that is accelerating with the proliferation of wireless networks.

Although the proportional market share for each of the above types of communications devices has not remained constant, each has maintained a place in the total mobile communications market. In retrospect, this can be attributed to the fact that each device has certain advantages with respect to the others in the performance of specific tasks. For example, laptop computers, although relatively bulky and difficult to transport, offer a user interface (i.e., display and keyboard) sized to facilitate visual and tactile interaction with the device. This suits the laptop to tasks such as reviewing and entering large amounts of textual information. A PDA is essentially a smaller version of a laptop; while this facilitates transport of the device, the necessarily small size of the display and keyboard makes user manipulation cumbersome. As such, textual input with a PDA is commonly limited to shorter messages.

With a form factor typically smaller than that of a PDA, cellular phones offer a popular option for mobile communications. However, while cellular phones are optimized for audio communications, in certain situations, the ability to interact visually via text rather than by voice is desirable (for example, when reviewing lengthy messages or documents). Modern cellular phones do often allow for textual communication by using the traditional 12-key phone keypad, but since several key presses can be required for basic letters, this is slow and only feasible for simple or isolated messages.

More recently, smart phones have allowed for the combination of cellular phone and PDA technology. These devices offer a lightweight option for communication by both voice and text. However, although some smart phones offer a larger keyboard and screen than regular cellular phones, the keyboards on these devices are still miniature and, as such, are more difficult and time consuming to use than full size computer keyboards. As a result, a smart phone user is still confronted with the two non-ideal options for responding to textual messages: (i) using the awkward textual input interface or (ii) placing a phone call to a telephone number associated with the originator of the textual message. Further, smart phones fail to offer users the smaller size and lower prices common to mass market mobile phones.

Aside from the textual input difficulties associated with cellular phones, many mobile electronic mail (“email”) products on these devices also tend to operate more slowly, from a user's perspective, than email software on laptop or desktop computers, due to the fact that many mobile email products on cellular phones utilize a “thin client” computing scheme for mobile email. In the “thin client“scheme, the device through which the user directly interacts contains minimal software for generating user interfaces. Instead, the device simply acts as a “browser”, sending user inputs over a network to a distant computer and displaying on the “local” or “client” device screen elements received from the distant computer. This is contrasted by the “thick client” approach frequently utilized in laptops, wherein the laptop (local device) contains the full complement of software required to complete various functions, including the software for generating user interfaces. In the thick client case, the network connection serves only to send and receive messages and data that the user can manipulate locally. In the thin client case, the network connection serves to deliver the majority of the actual interface to the user.

The thin client approach can be advantageous in some cases, as it facilitates “distribution” of new software by requiring only an update to the server. After such an update the change is reflected in the interface sent to the thin client. However, the thin client approach has the drawback of limiting “practical speed”. This comes from the fact that, each time the user must manipulate some data by way of the underlying software, instructions must be sent to the distant server and the user must wait for the task to be completed and the product to be returned. This wait time can be significant due to network latency (often ranging from 3 to 15 seconds per user instruction, depending on a variety of factors). It should be noted that this delay will be seen, for example, each time the user changes screens. As such, these events are common and user delays can be significant.

The thin client approach has a second disadvantage. Thin clients are dependent on a remote server not only for sending and receiving data, but to perform much of the processing required for data generation and manipulation. As such, thin clients are often not operational beyond the present screen at times when a network is unavailable. Conversely, thick client devices only require a network connection at isolated times in order to communicate, and at all other times can operate independently. This allows a thick client to be used at times when a network connection is inconvenient, expensive, or impossible, such as on airplanes or in isolated geographical areas.

In an effort to avoid some of the above logistical problems, various software solutions have been proposed. These solutions utilize existing hardware, but through interaction with the underlying software, the hardware is made to function in a new way. For example, European Application EP 1 185 068 A2 to Lewin et al., incorporated herein by reference in its entirety, discloses a voice SMS system using a handset interface layer coupled with other features such as a graphical user interface (GUI). This is a generic system for sending voice messages directly to a voicemail box rather than to an intended recipient's cell phone, by creating dynamic voice mailboxes on a server. Messages may later be retrieved by placing a cell phone call to the server. Lewin et al. deals only with voice messages between cell phones, and does not address the visualization or creation of textual messages. Further, Lewin et al. describes a telephone network for message transmission, which necessitates the charges associated with phone calls.

International Published Application No. WO 2004/080095 A1 to Northcutt, incorporated herein by reference in its entirety, describes a system and method for creating multimedia voice and text messages on a mobile phone. The system of Northcutt allows for a message composer to record a spoken message that can be sent as an audio file, along with text or other media. Northcutt helps to eliminate the problem of text entry on a numeric keypad or miniature keyboard. However, the system of Northcutt makes no provision for retrieving data from messaging servers such as email servers.

Over the last several years, various speech recognition software companies have made it possible to allow for voice control of software applications through “voice portals”. When using a voice portal, often by making a phone call with a telephone, menus of options are spoken to a user, who navigates through these menus by speaking selections. Such software is called “command and control” speech recognition software, and has been used to avoid tactile interfaces in mobile communications devices. As an example, European Application EP 1 280 326 A1 to Hazelaar, incorporated herein by reference in its entirety, describes a voice mail system with a voice-controlled interface for authentication. This allows voice mails to be sent from conventional telephones to a server, which then forwards audio messages to email accounts as sound attachments. The disclosure further allows a sender of a message to control message functions and destination via a voice-controlled interface. However, Hazelaar does not allow simultaneous and complementary audio, visual, and tactile interaction at the end user location, and provides no mobile access to email. Further, the act of attaching sound files makes the resulting message platform specific.

Some companies have added voice portal functionality to Web email, making it possible for users to listen to their email and speak replies. For example, International Published Application No. WO 02/054746 A1 to Ruotoisten-Mäki, incorporated herein by reference in its entirety, describes a speech user interface of a mobile station. In this disclosure, the mobile station is a so-called “thin client” which contains software that allows speech to be converted to electronic data to control the user interface. The disclosure allows for the retrieval of textual messages through text-to-speech synthesis, allowing the content of textual messages to be heard. Ruotoisten-Mäki, as with most voice portal approaches, has the disadvantage that an excessive length of time is required to listen to menu items to navigate the speech interface, to listen to a list of summaries of received message, and to listen to the synthesized text messages themselves, and this makes the service very inconvenient for most users. Users may only have the patience for such services when time is in abundance and visual interaction with the mobile station is undesirable, such as when operating a motor vehicle for extended periods.

### SUMMARY OF THE INVENTION

It thus would be desirable to provide a mobile communications device and system that allows for easy transportation of the device while avoiding the problems previously seen with textual entry. Such a system would further allow for accessing, visual review, and tactile navigation of email and/or textual messages, thereby providing an efficient way to assess such data.

Further, such a system should allow for visual display and tactile navigation of data and user options, as well as tactile data input. Such a communication device should be a thick client device, such that the user delay in communicating and user dependence on an active network connection for system functionality are minimized. The thick client approach is optimal for devices using mobile communications networks that are known for variable reliability. Further, such a communication device should be capable of communicating wholly over a data channel of the network, in order to avoid simultaneous telephone network and data network communications costs and the network latency associated with connecting a phone call. Moreover, such a communication device should allow for an interaction between the various communications functions, such that a variety of messages can be sent to any recipient device. For example, such a communication device would allow response to an email message by either a voice message (sent to the email address) or a textual reply.

In addition to the above, such communications devices would merge the various communications functions into one unit, so that text, voice, and multimedia communications were all available. Such a communication device is useable or adaptable for use with server technology in which the messaging architecture can handle message creation, receipt and response for any digitalizable message, in any format, via any popular messaging device, interface, or mode, that is received and delivered via any popular channel. For example, such a generic, multi-media, multi-channel, messaging (server application) architecture or system is disclosed in International Published Application No. WO 2004/095197 A2 commonly assigned with the present application.

In particular aspects, a software package would be provided that, in addition to enabling the above, would include features such as the ability to access and download messages from external messaging accounts and the ability to synchronize with external messaging system. Further, such software would be available as an over-the-air downloadable application, thereby reducing delivery cost and providing nearly instant delivery of the product.

Such a mobile communication device, system, and software beneficially reduce network latency, improve efficiency, and in general reduce time to use as compared to prior devices, systems, and methodologies. Consequently, the mobile communication device, system, and the methodology embodied in such devices and systems have the beneficial effect of overall improvement in the speed of the functions and actions by a user of the mobile communication device as compared to prior art devices and systems.

The present invention features a mobile communications device for communicating with a server over a network, the device including a visual interface device that displays data, an audio interface device that receives acoustic input and converts the acoustic input to data, a network connection, a memory containing an applications program, and a processor operably coupled to the visual interface device, the audio interface device, and the memory, wherein the applications program is executed on the processor. The applications program includes instructions, criteria and or code segments that locally generate graphical user interfaces with the visual interface and to control the input of data via the audio interface and the transmission of such data over the network to the server such that the data or instructions for data access are accessible to a recipient via a text-based application. In a particular embodiment, the mobile communications device further includes a tactile interface device for navigating data, the tactile interface device being operably coupled to the processor.

In another particular embodiment of the above mobile communications device, the applications program includes instructions, criteria and/ or code segments that allow for communicating via electronic mail. In this way, the device, more particularly the applications program, can be used to retrieve and visually review a listing of electronic mail messages with the visual interface device, to select a specific user-specified electronic mail message from the list to visualize with the tactile interface device, and to create a spoken response to the electronic mail message with the audio interface device for transmission and subsequent access and review via an electronic mail account.

In still another particular embodiment of the above mobile communications device, the audio interface device receives data and converts the data to acoustic output. The applications program also is arranged to receive data representing audio messages from a server and to play the received audio message(s) via the audio interface device.

The present invention also features a multimedia messaging system for communicating with a server, the server having an architecture including interface/connector subsystems that receive, process, and deliver messages that include metadata and whose content can be of different types delivered to and from devices and computer platforms of different types, over different channels, using different protocols and interfaces. The system includes a mobile communication device that is operationally coupled to the server. The mobile communication device includes a visual interface device that displays data, an audio interface device that receives acoustic input and converts the acoustic input to data, a network connection, a memory containing an applications program, and a processor operably coupled to the visual interface device, the audio interface device, and the memory, wherein the applications program is executed on the processor. The applications program includes instructions, criteria and/or code segments that locally generates graphical user interfaces with the visual interface and controls the input of data via the audio interface and the transmission of such data over the network to the server such that the data or instructions for data access are accessible to a recipient via a text-based application.

The present invention further features a computer readable medium whose contents cause a mobile communications device to perform messaging with a remote communications device. The mobile communications device includes an audio interface for converting an acoustic input to data representing the acoustic input and for converting data to acoustic output. The remote communications device also includes an applications program with functions for messaging. The contents of the computer readable medium includes code segments or the like as is known to those skilled in the art that cause such a mobile communications device to perform messaging by performing the steps of: generating graphical user interfaces in the mobile communications device by accessing instructions stored locally in the mobile communications device, storing locally in the mobile communications device data converted from acoustic input with the audio interface, transmitting the data representing acoustic input to a remote communications device via a data network such that the data or instructions for data access are accessible to a recipient via a text-based application.

The device of the subject invention can beneficially exploit newly-developed server technology, in which the messaging architecture is designed to handle message creation, receipt and response for any digitalizable message, in any format, via any popular messaging device, interface, or mode, that is received and delivered via any popular channel.

It should be appreciated that the present invention can be implemented and utilized in numerous ways, including without limitation as a process, an apparatus, a system, a device, a method for applications now known and later developed. These and other unique features of the system disclosed herein will become more readily apparent from the following description and the accompanying drawings, wherein like reference numerals identify similar structural elements.

Other aspects and embodiments of the invention are discussed below.

### BRIEF DESCRIPTION OF THE DRAWINGS

For a fuller understanding of the nature and desired objects of the present invention, reference is made to the following detailed description taken in conjunction with the accompanying drawing figures wherein like reference character denote corresponding parts throughout the several views and wherein:

FIG. 1 shows a simulated cellular telephone in accordance with the subject invention;

FIG. 2 shows the typical operating environment of a mobile communications device in accordance with the subject invention;

FIG. 3 shows a block diagram that illustrates the process by which an exemplary embodiment of the client computer program functions in controlling communications between a mobile communications device and a server;

FIGS. 4a-h show a progression of views representing the GUIs that would be visible to a user through the process of creating and sending a spoken email;

FIG. 5 shows a functional block diagram of the functional components of the client computer program;

FIG. 6 shows a flowchart depicting a process that enables communication between a mobile communications device and a server;

FIG. 7 shows a flowchart depicting the process steps undertaken by the client computer program in enabling a communications device-to-server request;

FIG. 8 shows a flowchart depicting the process steps undertaken by the client computer program in enabling the retrieval of communications responses from a server;

FIG. 9 shows a flowchart depicting a process by which communication including the transfer of a voice file is enabled;

FIG. 10 shows a flowchart depicting the process steps undertaken by the client computer program in receiving from a server and processing XML-formatted Base64 encoded voice messages;

FIG. 11 shows a flowchart depicting the process steps undertaken by the client computer program in recording a voice message;

FIG. 12 shows a flowchart depicting the process of reviewing a received voice message as enabled by the client computer program;

FIG. 13 shows a flowchart depicting the process of downloading the client computer program from the mobile communications device via a distribution network;

FIG. 14 is a block diagram showing a messaging server application architecture particularly suited for use with the mobile communications device and software of FIGS. 1-13;

FIG. 15 is a more detailed block diagram of the voice user interface gateway shown in FIG. 14;

FIG. 16 is a more detailed block diagram of the data gateway shown in FIG. 14 illustrated to show pure HTTP and/or Web Service connections;

FIG. 17 is more detailed block diagram of the messaging connector shown in FIG. 14; and,

FIG. 18 is a more detailed block diagram of the content transformer shown in FIG. 14.

### DETAILED DESCRIPTION OF PREFERRED EMBODIMENTS

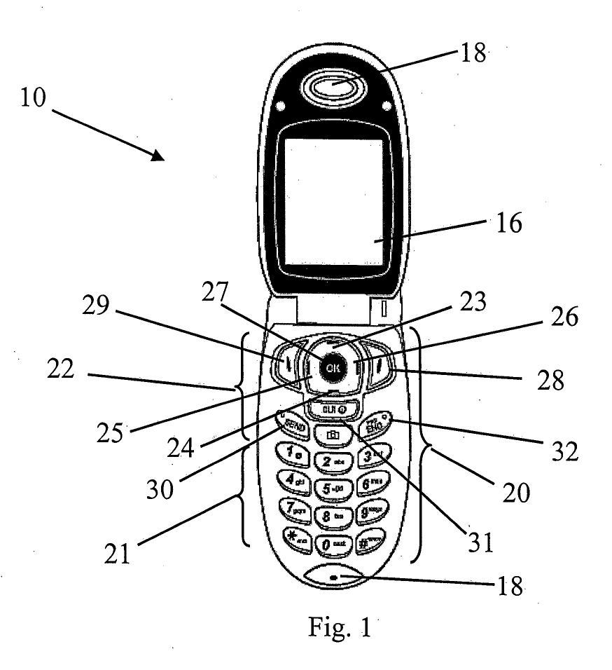

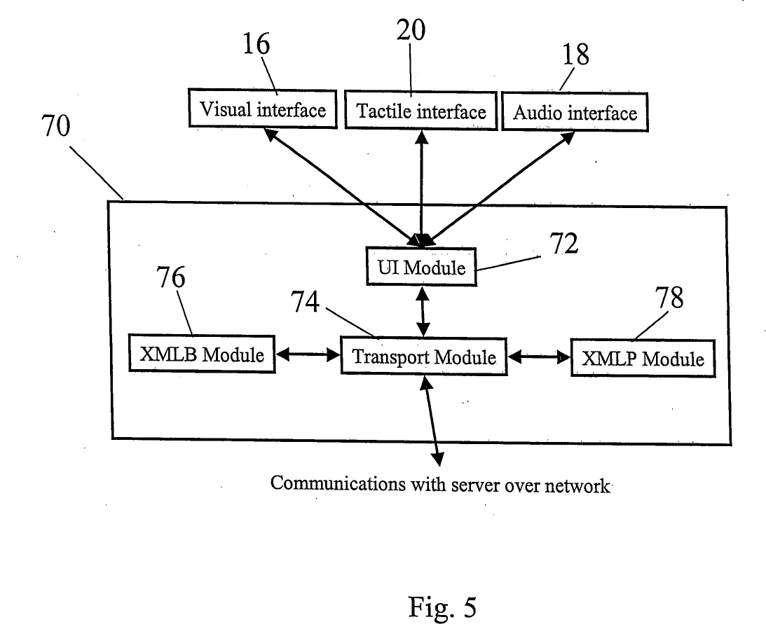

FIG. 1 shows a cellular telephone or phone 10 configured in accordance with the present invention. The cellular phone 10 is an exemplary vehicle for the present invention, however, the present invention is not limited to cellular phones, and is compatible with any conventional mobile communications device including a pager, PDA, handheld computer, smart phone, wearable computer, a laptop, or some other portable device as is known to those skilled in the art or hereinafter developed and adaptable for use with the present invention. Phone 10 includes a memory in which is stored (locally) a client computer program (also called “client program” or “program”) 70 (FIG. 5). The memory can be of any variety appropriate for mobile electronics, such as read-only memory (ROM), programmable read-only memory (PROM), erasable programmable read-only memory (EPROM), random access memory (RAM), dynamic random access memory (DRAM), static random access memory (SRAM), non-volatile random access memory (NVRAM), magnetizable media, combinations thereof, or other types of memory well known to those skilled in the art. Phone 10 also has a processor for running the client computer program 70, the client computer program 70 controlling some functional aspects of device.

Phone 10 includes a visual interface 16, an audio interface 18, and a tactile interface 20 (e.g., buttons, keys, glide point, and the like), each existing in a control relationship with the client computer program 70 and allowing a user to interact with the phone 10 in a different manner. The visual interface 16 allows for the display of GUI screens generated by the client computer program, the GUI allowing for the orderly visualization of data. In a particular embodiment, the visual interface is a liquid crystal display (LCD). The audio interface 18 receives acoustic input and converts the input to electrical data that can then be operated on by the client computer program 70. Audio interface 18, for example, could be a microphone that converts speech into a binary sound file. In an exemplary form, audio interface 18 also includes a speaker that allows the user to hear received voice messages and other audio information.

The tactile interface 20 includes a keypad 21 for use with program 70 and provides a mechanism for a user to manually input data into the phone 10. The tactile interface 20 also includes navigational keys 22 that work in conjunction with the visual interface 16 to allow a user to navigate between and select options made available by program 70 and displayed on the visual interface 16. For example, in a particular embodiment, the navigational keys 22 include an “UP” directional key 23, a “DOWN” directional key 24, a “LEFT” directional key 25, a “RIGHT” directional key 26, and an “OK” navigational key 27, as well as soft keys 28, 29, and dedicated “SEND” 30, “CLR” (representing “clear”) 31, and “END” 32 buttons.

When a list of items is displayed on the visual interface 16, depressing the UP and DOWN keys 23, 24 allows the user to scroll through the list of items, the OK key 27 then allowing the user to choose one item for further operation. In instances where, for example, text is being entered in a field in a GUI, the directional keys 23-26 are used to move a cursor within the field. The soft keys 28, 29 allow the user to make selections directly from GUIs displayed in the visual interface 16. The dedicated buttons 30-32 make commonly used options to be readily available to a user, e.g., in ending an ongoing process with the END button 32.

It should be recognized that the foregoing arrangement for the tactile interface is exemplary and that it is contemplated and thus within the scope of the present invention, for other physical configurations and input mechanisms are useable to form a tactile interface for use with the present invention.

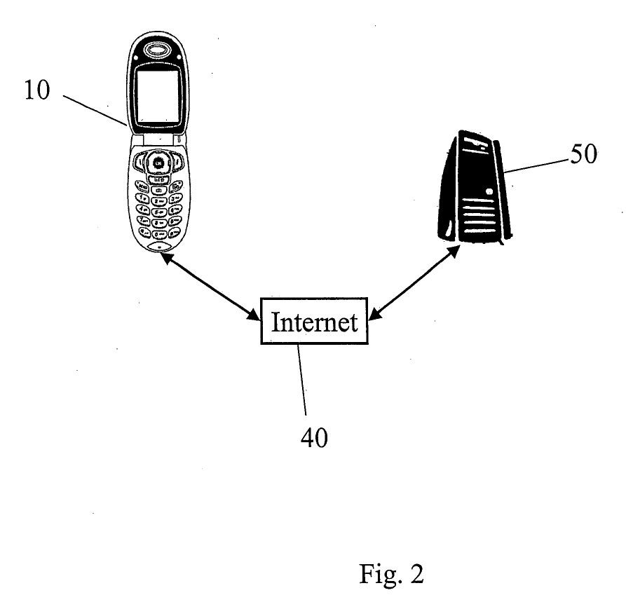

Phone 10 also includes a network connection device (not shown). In a particular embodiment, the network connection device is a wireless connection device such that the phone 10 does not need to be physically connected to a network to communicate. Many devices and methods are available for providing a wireless network connection for a cell phone, these devices and methods being well known to those skilled in the art and including, for example, 1×Radio Transmission Technology (1×RTT) networks, 1×RTT “evolution data only” (EVDO) networks, Global System for Mobile Communications (GSM) networks, GSM “Enhanced Data GSM Environment” (GSM EDGE) networks, Code-Division Multiple Access (CDMA) networks, Wideband CDMA (WCDMA) networks, CDMA2000 networks, 802.11 networking (i.e., “WiFi”), and connecting to a separate, networked device via the BLUETOOTH® radio-frequency standard maintained by the Bluetooth Special Interest Group of Overland Park, Kans. The network connection allows phone 10 to connect to a network 40, as illustrated in FIG. 2. In an exemplary embodiment, the network 40 is a data network using the Hypertext Transfer Protocol (HTTP) over transfer control protocol/internet protocol (TCP/IP). Also connected to the network 40 is one or more servers 50 such that the network 40 provides a communications path between phone 10 and server 50, i.e., provides a path for the bi-directional transmission of data. In a particular embodiment, the server 50 supports the use of extensible markup language (XML)-based protocol. It should be noted that, while several of the embodiments of the present invention are described with reference to XML, there is no inherent requirement for one programming language or platform. It is contemplated and thus within the scope of the present invention for any programming language known to those skilled in the art be used with the present invention, such programming languages including but not limited to: Java, C, C+ +, Fortran, Handheld Devices Markup Language (HDML), Wireless Markup Language (WML), compact HyperText Markup Language (cHTML), Java 2 Micro Edition (J2ME), and Extensible HyperText Markup Language (XHTML).

From this point forward, reference should be made to FIG. 1 when referring to the visual interface 16, audio interface 18, tactile interface 20, keypad 21, navigational keys 22, directional keys 23-26, OK key 27, soft keys 28, 29, dedicated SEND button 30, CLR button 31, and END button 32. As such, references to figures not containing those numerals implicitly refer to FIG. 1. Further, reference should be made to FIG. 2 when referring to the mobile communications device or phone 10, the network 40, or the server 50. As such, references to figures not containing those numerals implicitly refer to FIG. 2.

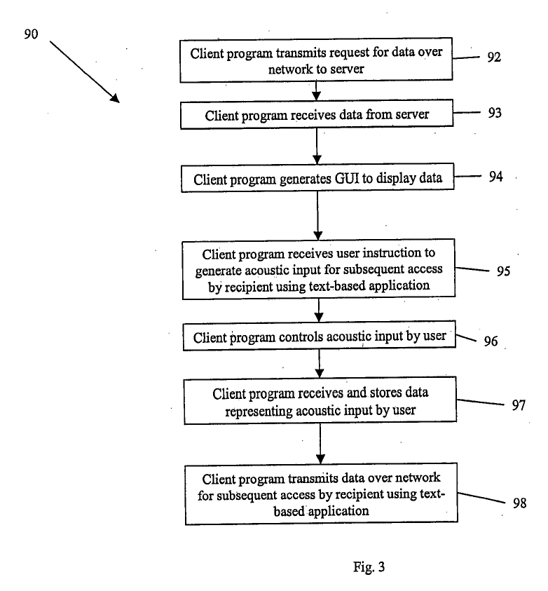

Referring to FIG. 3, there is shown a block diagram that illustrates the process by which an exemplary embodiment of the client computer program 70 functions in controlling communications. Program 70 initiates communications by transmitting a request for data to the server 50 (step 92). This request is made over the network 40 that is, for example, a data network. In response to the request, the server 50 sends data, and those data are received by the program 70 (step 93). The program 70 generates a GUI so that the data can be visualized and processed by a user (step 94). Once the data have been processed by the user, the user instructs program 70 that data are to be generated acoustically by the user and made available to a recipient using a text-based application (step 95). Typically, the user generates such acoustic data by speaking. Program 70 controls the input of acoustic data by the user (for example, by alerting the user as to when such input may be made) (step 96), and receives and stores data representing that input (step 97). Finally, the stored data are transmitted to the server 50 over the network 40 for access by a recipient. The recipient uses a text-based application (e.g., email) to access the data or instructions for retrieving the data.

Generally, there are several typical forms that the communications between a mobile communications device 10 and a server 50 can take. For example, the communications may consist of sending information (such as messages) for storage or further processing at the server 50. Alternatively, in many cases, the server 50 contains data regarding email messages, voice messages, multimedia messages, and other forms of information, and the mobile communications device 10 is used to retrieve that information. In the present invention, the client computer program 70 enables both types of communications. Specifically, a cellular phone 10 running program 70 allows a user to connect to network 40 and retrieve email messages from server 50. Those messages are then displayed in textual format on the visual interface 16, by way of a GUI generated by program 70. The user, by using the tactile interface 20, can navigate the displayed list of messages in the GUI and select individual messages to read, forward, delete, etc. In cases where the user wishes to respond to a message, the audio interface 18 allows for a spoken message to be recorded by program 70 as a data file. The data file is subsequently transmitted over the network 40 by program 70 to be accessed by the user of an email account via that account. In a particular embodiment, the data file representing the spoken message is a binary data file.

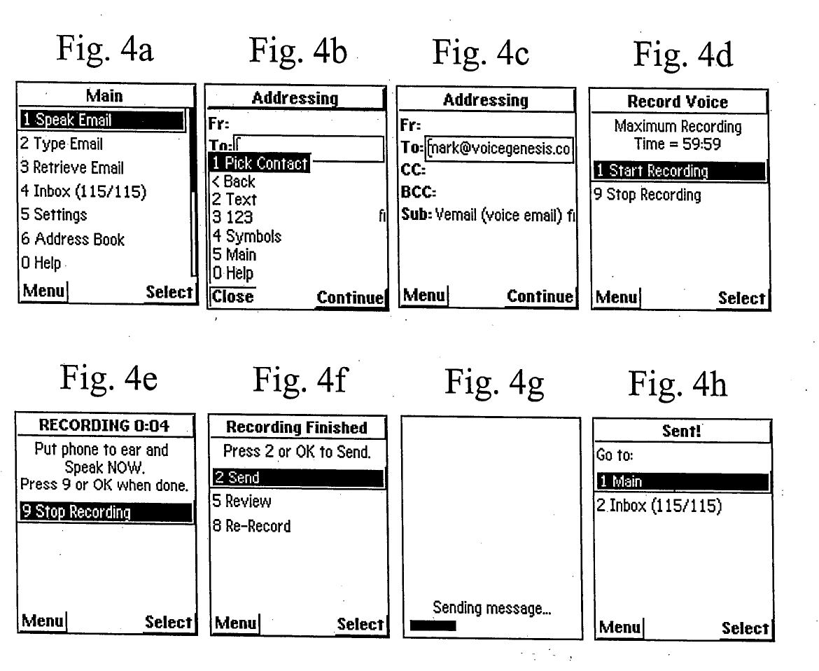

Referring to FIGS. 4a-h, one specific category of communications between phone 10 and server 50 is the creation of email at phone 10 to be sent to an email account. The figures also illustrate exemplary GUI menus being displayed and the steps taken in generating a spoken email message. First, the user navigates an introductory menu (FIG. 4a), using the UP and DOWN keys 23, 24 to scroll to the entry “Speak Email” and the OK key 27 to choose this option. This action prompts a GUI screen related to addressing the message, and allows the user to choose to select the message destination information from a list of contacts stored in the device (FIG. 4b), such as, for example, in an address book stored in the memory, or to type/manually input address information using the keypad 21. In either case, the email address to which the message will be sent is displayed in the GUI (FIG. 4c). In further embodiments, the user is given the option of changing the default subject for the message. Next, a “Record Voice” GUI screen is displayed (FIG. 4d), allowing the user to use the navigational keys 22 to choose “Start Recording”. In particular embodiments, the client computer program 70 calculates a duration limit (e.g., a maximum duration) for the voice message and causes the calculated duration limit to be displayed with a GUI. Once this option is chosen, a GUI will alert the user that the device is recording (FIG. 4e). The user then proceeds to speak the message and it is recorded, processed by program 70, and stored as a data file in the memory or other storage area of the mobile communication device/phone 10. Such recording is stopped by action of the user again by using the navigational keys 22 to choose an option displayed on the GUI. In a further embodiment, recording is automatically stopped after it is determined that the calculated duration for the voice message is reached. When recording is stopped, the “Recording Finished” GUI screen is displayed (FIG. 4f). This GUI allows the user to send the message to the specified address or addresses, to review the recorded message, or to re-record the message. The user can depress the CLR or END keys 31, 32 to cancel the message. Once the user has elected to send the message, another GUI screen alerts the user that the message is being transmitted (FIG. 4g). The client computer program 70 as herein described takes the appropriate actions and functions so as to cause the message (e.g., in the form of the data file) to be transmitted, for example, to the server 50. If transmission is successful (e.g., a message is received from the server 50 acknowledging receipt of message), another GUI screen is displayed that informs the user that the message has been sent, and provides options for proceeding (FIG. 4h). If the network connection is interrupted during transmission such that the message is not successfully sent, then another GUI screen is displayed that alerts the user to the error and provides an opportunity for the user to re-transmit the message.

Another specific category of communications between phone 10 and server 50 is the creation and sending of text messages from the phone 10 to the server 50. As with the process described above the user navigates an introductory menu (FIG. 4a), using the directional keys 23-26 to scroll to the entry “Type Email” and the OK key 27 to choose this option. This action prompts the display of a GUI screen related to addressing the message, and allows the user to choose from a list or input the message destination information. The email address to which the message will be sent is displayed in another GUI screen. In further embodiments, the user is given the option of typing the subject for the message. The user then is alerted that the message can be inputted, for example by displaying another GUI screen. The user then proceeds to input the text message using the keypad 21 and other appropriate keys, buttons, and the like, which is processed by the client computer program 70 and stored as a data file in the memory or other storage area of the mobile communication device/phone 10. After the user indicates that they are finished, another GUI screen is displayed that allows the user to send the message to the specified email address. Alternatively, the GUI can be arranged so the user also can cancel the message. Once the user has elected to send the message, another GUI alerts the user that the message is being transmitted. The client computer program 70 also takes the appropriate actions and functions so as to cause the text message (e.g., in the form of the data file) to be transmitted, for example, to the server 50. If transmission is successful (e.g., a message is received from the server 50 acknowledging receipt of message), another GUI is displayed informing the user that the message has been sent, and can provide options for proceeding. If the network connection is interrupted during transmission or the text message is otherwise not successfully sent, then another GUI is displayed that alerts the user to the error and provides an opportunity for the user to re-transmit the text message.

Yet another specific category of communications between phone 10 and server 50 is the process by which the user can retrieve a list of messages to the phone 10 from the server 50. As with the process described above, the user navigates an introductory menu (FIG. 4a), using the directional keys 23-26 to scroll to the entry “Inbox” and the OK key 27 to choose this option. A message/request is then outputted by the mobile communication device/phone 10 to the server 50, responsive to this prompt/action of the user. The message/request solicits the desired information contained in the folder (i.e., Inbox) for the targeted or requesting user/email address. In particular embodiments, the mobile communication device 10 also determines available RAM and storage and communicates this information with the message to the server 50. The client computer program 70 also takes the appropriate actions and functions necessary to cause the message to be transmitted to the server 50. Thereafter, the server 50 responsive to this request returns the requested information to the mobile communication device/phone 10 which is in turn stored in the memory or phone storage area. If server transmission is successful (e.g., a message list is received from the server 50), another GUI is displayed informing the user that the message list has been received and stored sent in the phone. If the transmission of the information or subsequent storage of the message list is otherwise not successfully sent, then another GUI is displayed that alerts the user to the error and provides an opportunity for the user to re-transmit the request.

As this information is present/stored in the phone 10, the user can take the appropriate actions to cause such information to be displayed. In particular embodiments, the user can choose or select a message appearing in the Inbox list. A message/request is then outputted by the mobile communication device/phone 10 to the server 50; which requests the server to transit the requested email message from the appropriate folder for the targeted or requesting user/email address. In particular embodiments, the mobile communication device 10 also determines available RAM and storage and communicates this information with the message to the server 50. The client computer program 70 also takes the appropriate actions and functions necessary to cause the message/request to be transmitted to the server 50. Thereafter, the server 50, responsive to this request, returns the requested information to the mobile communication device/phone 10 which is in turn stored in the memory or phone storage area. Upon receipt of the returned message, the client computer program 70 determines if the retrieved message is a text message, a text and voice message, or a voice-only message. Thereafter the appropriate actions are taken so that the message, in whatever form it is in, is provided to the user.

Yet another specific category of communications between phone 10 and server 50 is the process by which the user can retrieve or import a database, such as contact database, to the phone 10 from the server 50. As with the process described above, the user navigates an introductory menu (FIG. 4a), using the directional keys 23-26 to scroll to the entry “Address Book” and the OK key 27 to choose this option. A message/request is then outputted by the mobile communication device/phone 10 to the server 50, responsive to this prompt/action of the user. The message/request solicits the desired database for the targeted or requesting user/email address. In particular embodiments, the mobile communication device 10 also determines available RAM and storage and communicates this information with the message to the server 50. The client computer program 70 also takes the appropriate actions and functions necessary to cause the message to be transmitted to the server 50. Thereafter, the server 50, responsive to this request, returns the requested database/contact database to the mobile communication device/phone 10 and stores it. Following receipt of the database, the client computer program 70 deletes the existing database, if any.

Yet another specific category of communications between phone 10 and server 50 is the process by which settings, such as the user's account settings, are created, changed and updated between the mobile communication device/phone 10 and the server 50. The user's account settings are stored in a local database on the phone 10. The following process is used when the user decides to update settings, such as the account settings, which are stored on both the mobile communication device/phone 10 and the server 50. As with the process described above the user navigates an introductory menu (FIG. 4a), using the directional keys 23-26 to scroll to the entry “Settings ” and the OK key 27 to choose this option. A GUI is then presented that allows the user to view, add, change, delete, or import settings. Depending on the action taken by the user, a message/request is then outputted by the mobile communication device/phone 10 to the server 50, responsive to this prompt/action of the user. This message/request solicits the desired information or database/settings database information for the targeted or requesting user/email address. In particular embodiments, the mobile communication device 10 also determines available RAM and storage and communicates this information with the message to the server 50. The client computer program 70 also takes the appropriate actions and functions necessary to cause the message to be transmitted to the server 50. Thereafter, the server 50 responds to the request as appropriate and returns the appropriate information to the phone 10 to be stored in the appropriate location/database. If server transmission is successful (e.g., a message is received from the server 50), another GUI is displayed informing the user that the message has been received and stored sent in the phone. If the transmission of the information or subsequent storage of the message is otherwise not successfully sent, then another GUI is displayed that alerts the user to the error and provides an opportunity for the user to re-transmit the request. As this information is present/stored in the phone 10, the user can take the appropriate actions to cause such information to be displayed.

The general strategy described above for receiving, reviewing, and responding to messages using a combination of visual, tactile, and audio methods of user interaction is a highly efficient method for completing such tasks. The method allows for visual review of lists of data (such as a list of pending email messages) and the prioritization of individual items within the list for attention. This is a significant improvement over systems in which an entire list must be thoroughly reviewed in the order it is presented (e.g., as is the case with “voice portals” for message retrieval). Further, the method allows a user to visually review the contents of a message, which is both quick and accurate. Additionally, responding by voice allows a user to avoid the need to input large amounts of text on a small and awkward tactile interface (e.g., a keypad on a conventional cellular phone). At the same time, because spoken messages are recorded as data files, a user is not prohibited from transmitting responses to email accounts simply because the response is given in spoken form. Rather, users of email accounts can access the messages in spoken form from their email account. Additionally, the ability to record a spoken message in its entirety before it is transmitted to the server (i.e., the ability to “store and forward”) allows the user to review the message for accuracy and also greatly increasing the likelihood that the message is transmitted without being distorted (e.g., truncated) by network unavailability.

Referring to FIG. 5, there is illustrated a block diagram that schematically shows the functional components of an exemplary embodiment of the client computer program 70 according to the present invention. Program 70 generally separates its functions between the User Interface (UI) Module 72, the Transport Module 74, the XML Builder (XMLB) Module 76, and the XML Processor (XMLP) Module 78. The UI Module 72 is responsible for the display of GUIs that enable user interaction and for invoking other portions of the program 70 based on those interactions. In a particular embodiment, the mobile communications device 10 on which program 70 is running is a mobile phone; the UI Module 72 then utilizes the software development kit (SDK) typically included with the mobile phone to generate the GUIs. The Transport Module 74 governs interactions between the communications device 10 and the server 50. The XMLB and XMLP Modules 76, 78 prepare requests to be sent to the server 50 in XML format and parse XML responses from the server 50 to be operated on by the other modules, respectively.

From this point forward, reference shall be made to FIG. 5 when referring to the client computer program 70, the UI Module 72, the Transport Module 74, the XMLB Module 76, or the XMLP Module 78. As such, references to figures not containing those numerals implicitly refer to FIG. 5.

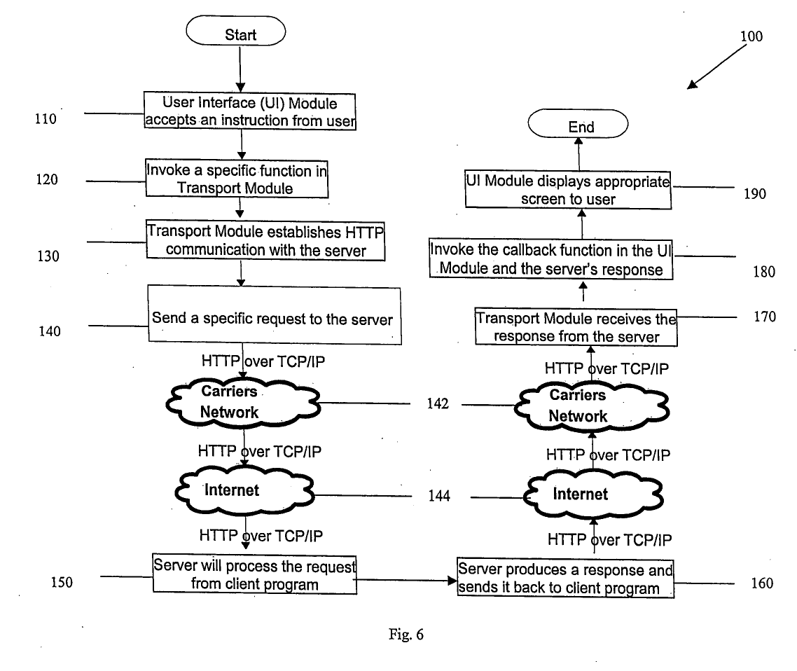

FIG. 6 illustrates a flowchart 100 depicting a process by which communication is enabled between a mobile communications device 10 and a server 50, in accordance with an embodiment of the present invention. Referring to FIG. 6, at step 110, the UI Module 72 accepts an instruction entered by a user; this serves to initiate communication. In a particular embodiment, this instruction is entered using an interface 16, 18, 20 of the communications device 10, based on options displayed in a GUI. At step 120, a specific function is invoked within the Transport Module 74 in response to this instruction. At step 130, Transport Module 74 establishes communication with the server 50 (e.g., HTTP communication over a cellular phone carrier network 142 and over the Internet 144). This is followed by step 140, in which a specific request is sent to the server 50. At step 150, the server 50 processes the request received from the Transport Module 74. In cases where data are simply being sent to the server 50 for storage or disposition, this completes the communication process.

As discussed, in some cases a request to the server 50 will require data to be returned to the user. At step 160, the server 50 generates a response and returns the response in the form of the requested data, which travel over network 40 to the mobile communications device 10 (e.g., over an HTTP channel of the appropriate cellular phone carrier network 142 and over the Internet 144). At step 170, the Transport Module 74 receives the response from the server 50. At step 180, the Transport Module 74 invokes a callback function in the UI Module 72 to pass on the data returned from the server 50. Finally, at step 190, the UI Module 72 displays the data in a manner appropriate for review by the user, thereby completing the process. For example, such data might consist of a series of email messages and be displayed as a list (e.g., email Inbox list) so as to allow a user to review sender information, individual messages a contact database for database updating purposes and the like. In further embodiments, the Transport Module 74 also forwards information concerning the amount of free RAM/ storage to the server and the server in turns determines an amount of information that can be sent back based on the received information. In the case where the returned data are a database update, such as for example an update to the contact database, the client computer program causes the existing database to be deleted and replaced with the updated database.

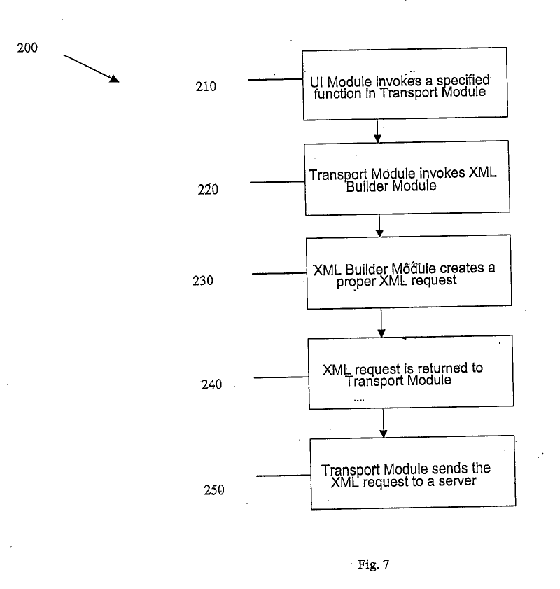

FIG. 7 illustrates a flowchart 200 depicting the process steps undertaken by the client computer program 70 in enabling the communications device-to-server request shown in FIG. 6 and described herein. Referring to FIG. 7, at step 210, the UI Module 72 receives a user instruction and invokes a specific function in the Transport Module 74. For example, in a particular instance, the UI Module 72 instructs the Transport Module 74 that a message is to be sent to the server 50. Next, at step 220, the Transport Module 74 invokes the XMLB Module 76. At step 230, the XMLB Module 76 composes an XML request corresponding to the user instruction. At step 240, the XML request is returned from the XMLB Module 76 to the Transport Module 74. At step 250, the XML request, now formatted to be accepted by the server 50, is sent by the Transport Module 74 to the server 50. For example, in the particular case where program 70 is composed using the BREW® software development platform available from QUALCOMM, Inc. of San Diego, Calif., the Transport Module 74 uses the “ISHELL_CreateInstance( )” and “ISOURCEUTIL_PeekFromMemory( )” functions to prepare the XML-based request for transmission to the server 50. The Transport Module 74 further invokes the “CALLBACK_Init( )” function included in BREW® to prepare a call-back function for receiving the response from the server 50. Finally, the Transport Module 74 invokes the “IWEB_GetResponse( )” function, which initiates the connection to the server 50 and transmits the request.

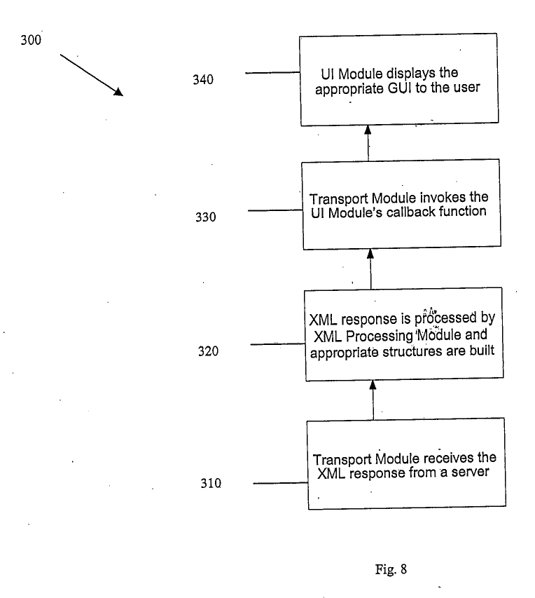

FIG. 8 shows a flowchart 300 depicting the process steps undertaken by the client computer program 70 in enabling the retrieval of responses from the server 50 as shown in FIG. 6 and described herein. Referring to FIG. 8, at step 310, the Transport Module 74 receives an XML response from the server 50. This response includes the result for successful processing of a user's request (or, it will contain an error message if the processing of the request was unsuccessful). At step 320, the XML response is sent to the XMLP Module 78 to build the appropriate data structures for later manipulation by the other modules. The building of the data structures is governed by the content of the response from the server 50. At step 330, the Transport Module 74 invokes the callback function of the UI Module 72 to allow passing on the data structures to the UI Module 72. Finally, at step 340, the UI Module 72 displays the data in a manner appropriate for review by the user.

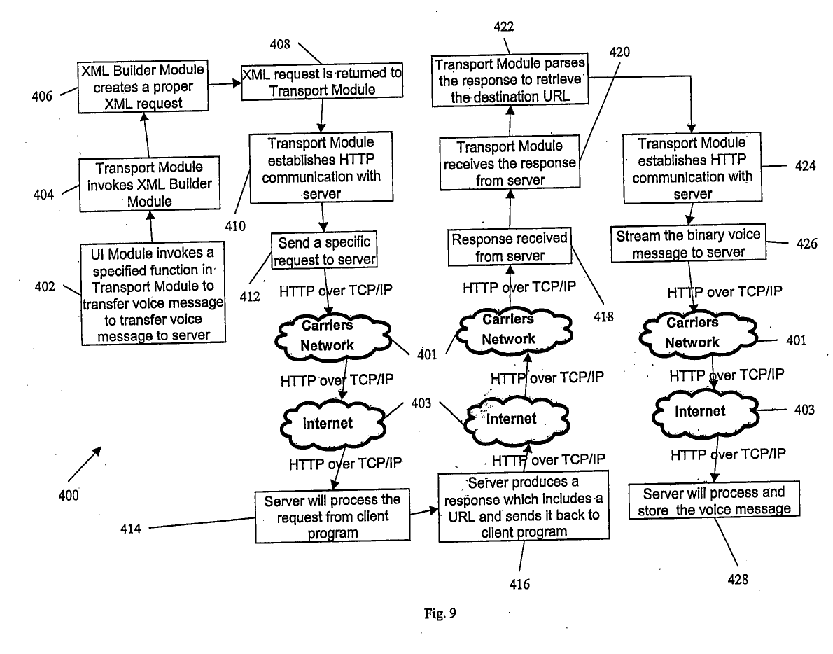

Generally, the Transport Module 74 completes its communication with the server 50 in a single round-trip. This is not the case, however, when data representing a recorded voice message (i.e., “voice data”) are included in the data file being transferred to the server 50; such a file is sometimes referred to as a “voice file”. Referring to FIG. 9, there is illustrated a flowchart 400 depicting an exemplary process by which communication including the transfer of a voice file is enabled by program 70. At step 402, the UI Module 72 invokes a specific function within the Transport Module 74 in response to a user instruction. At step 404, the Transport Module 74 invokes the XMLB Module 76. At step 406, the XMLB Module 76 composes a request (e.g., in XML) corresponding to the user instruction, which is returned to the Transport Module 74 at step 408. At step 410, the Transport Module 74 establishes communication with the server 50 (e.g., over an HTTP channel of the appropriate cellular phone carrier network 401 and over the Internet 403). This is followed by step 412, in which a specific request is sent to the server 50 via a data channel. At step 414, the server 50 processes the request received from the Transport Module 74. At step 416, the server 50 generates a response that travels over the network 40 (e.g., an HTTP channel of the of the appropriate cellular phone carrier network 401 and over the Internet 403) and is received at step 418 by the mobile communications device 10 and at step 420 by the Transport Module 74. The response from the server 50 includes a uniform resource locator (URL) that is subsequently utilized to store the recorded voice message. At step 422, the Transport Module 74 parses the response from the server to retrieve the destination URL information. At step 424, the Transport Module 74 again establishes communication with the server 50 (e.g., via an HTTP channel of the of the appropriate cellular phone carrier network 401 and over the Internet 403). At step 426, the Transport Module 74 transmits a voice file to the server 50 using a data channel, such use often having attendant speed and cost advantages with respect to a voice channel as known to those skilled in the art. Finally, at step 428, the server 50 processes the data sent by the Transport Module 74 and stores the voice file.

The above process for sending voice files has several advantages. Specifically, a user can record a voice message in binary format and transmit the binary file without the need to transform the file, thereby saving time.

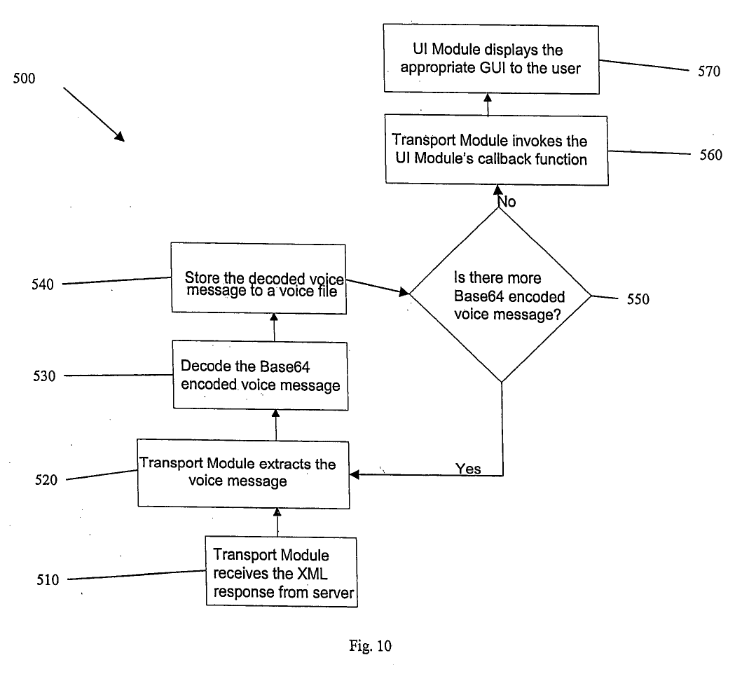

A user of a mobile communications device 10 configured in accordance with the subject invention may also receive voice messages from another user of a similar mobile communications device. Referring to FIG. 10, there is illustrated a flowchart 500 depicting the process steps undertaken by the client computer program 70 in enabling the retrieval of XML-formatted, encoded voice files stored on server 50. At step 510, the Transport Module 74 downloads the XML data file from the server 50 (i.e., receives and stores the file locally within the mobile communications device 10). The file includes header information that allows the portion containing the encoded binary voice data to be separated from the rest of the file. At step 520, the encoded binary voice data are extracted by the Transport Module 74, the extraction being enabled by the header information. At step 530, the encoded binary voice data are decoded by the Transport Module 74 as the voice data are extracted, and at step 540 the decoded data are stored to as a sound file in the memory of device 10. At step 550, the Transport Module 74 checks to see if there are more of the voice data to be extracted and decoded. If there are, the Transport Module 74 will repeat steps 520, 530, and 540 until all the voice data are completely decoded. When all the voice data have been decoded, the Transport Module 74 proceeds to step 560 to notify the UI Module 72, via a callback function, that a voice message is received. At step 570, the UI Module 72 then displays an appropriate GUI to the user, who can use the options in the GUI to play the stored sound file. As such, the sound file can be listened to by a user, in much the same way that conventional voice messages are audibly reviewed via telephone. However, in the case of the present invention, the sound file has arrived via an email account. It should be noted that the described method for receiving voice files, in which encoded binary data are formatted in another language for transmission and extracted upon receipt, is generally useful for receiving and processing large files. For example, in a particular embodiment, this scheme can be used for downloading large data files containing contact information.

The above process for receiving voice files has several advantages. Specifically, when the voice files being received contain encoded (e.g., Base64 encoded) binary data representing sound, those encoded data being embedded in an alternative format (e.g., XML-based), the ability to separate the encoded portion from other portions of the file obviates the need to parse the entire file, thereby saving time. This is also desirable when the memory available for locally storing such files is limited (as is often the case in mobile communication devices), as it reduces the need to create redundant copies of the involved files. Memory demands are further reduced by decoding the voice message as it is being extracted, further obviating the need for extra file copies.

It should be clear that a device configured in accordance with the subject invention is capable of operating independently, without need for an active connection with a server. The client computer program 70 locally provides all of the capabilities necessary to compose text and voice based messages, generate GUIs for displaying and playing downloaded text messages and voice messages, respectively, and for processing user inputs via the interfaces. Specifically, downloaded text messages are stored as text files and downloaded voice messages are stored as binary voice files. The UI Module opens the message file, constructing an appropriate GUI. A network connection is needed only to send and receive data to/from a server, but not to operate on those data. As such, network connection is only needed at isolated intervals, and much communications device use can take place without a network available (i.e., the device is a thick client).

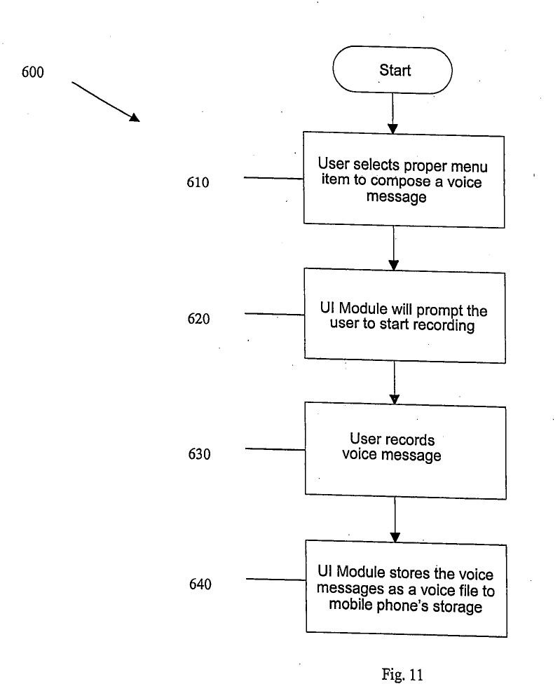

Referring to FIG. 11, there is illustrated a flowchart 600 depicting the process steps undertaken by the client computer program 70 in recording a voice message. The process begins in step 610, wherein the user selects the proper menu item from a list displayed in a GUI to compose a voice message (FIG. 4a). Next, at step 620, the UI Module 72 will alert the user that recording has started. At step 630, the user records a spoken message. Finally, at step 640, the recorded message is stored as a sound file in the memory of the mobile communications device 10.

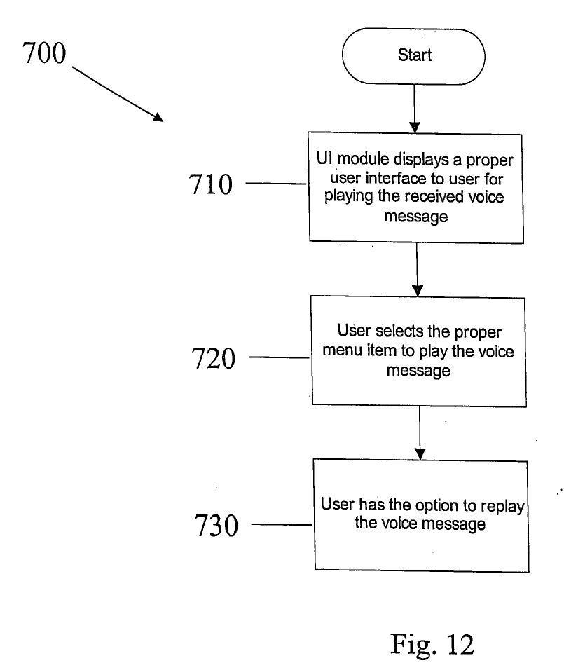

Much of the prior discussion has focused on the ability of a mobile communications device equipped with the client computer program 70 to allow interaction with email, including visual review of messages and spoken replies. However, it is contemplated that the client computer program 70 allows the receipt of voice messages from standard or cellular telephones. Further, the client computer program 70 also allows for voice messages sent to email accounts by other cellular telephones likewise equipped with the program 70 to be received and played as sound, and similarly to be responded to with voice messages. These actions are also governed by GUIs generated by the UI Module 72 of the client computer program 70. Referring to FIG. 12, there is illustrated a flowchart 700 depicting the process of reviewing a voice message received via an email account from a cellular phone running program 70. At step 710, the UI Module 72 displays a GUI that allows a user to choose to listen to a received voice message. At step 720, the user selects the appropriate menu item from the GUI to play the voice message. After the message has played, at step 730, the user is given the option to replay the message.

In an exemplary embodiment, the client computer program 70 is based on the BREW® (Binary Run-time Environment for Wireless) software development platform available from QUALCOMM, Inc. of San Diego, Calif. This facilitates the practical advantage of allowing for over-the-air distribution of program 70 to mobile communications devices via a distribution network, such as the BREW Distribution System (BDS) available from QUALCOMM, Inc. The BDS can be accessed through various carriers, such as Verizon Wireless of Bedminster, N.J. In short, another advantage of the present invention is that the program 70 that controls the messaging functions of this invention can be downloaded to an existing device (e.g., a conventional cellular phone as shown in FIG. 1) to upgrade its functionality.

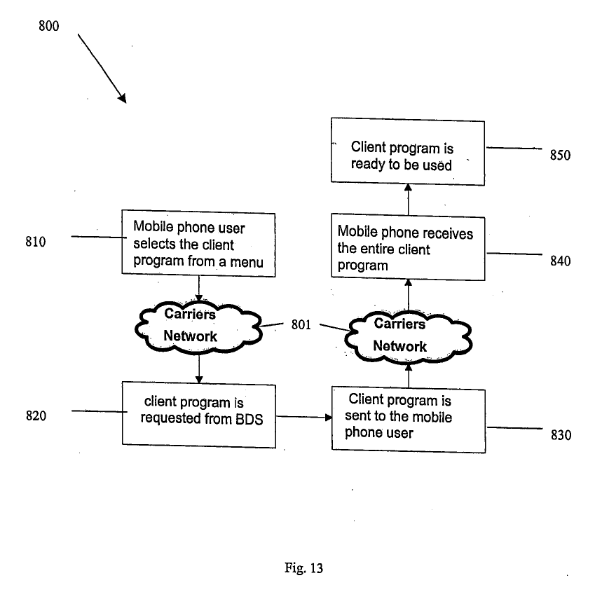

Referring to FIG. 13, there is illustrated a flowchart 800 depicting an exemplary process by which the client computer program 70 is downloaded to a mobile communications device 10 via the BDS. At step 810, the user selects the client computer program 70 from a GUI listing applications available to be downloaded via the BDS. Next, at step 820, the request is sent to the server via a cellular phone carrier network 801. At step 830, the client computer program 70 is transmitted over the BDS (via the cellular phone carrier network 801) to the mobile communications device 10, where, at step 840, the program 70 is received and stored in the memory. At step 850, the process is concluded and the client computer program 70 is available for use with the mobile communications device 10.

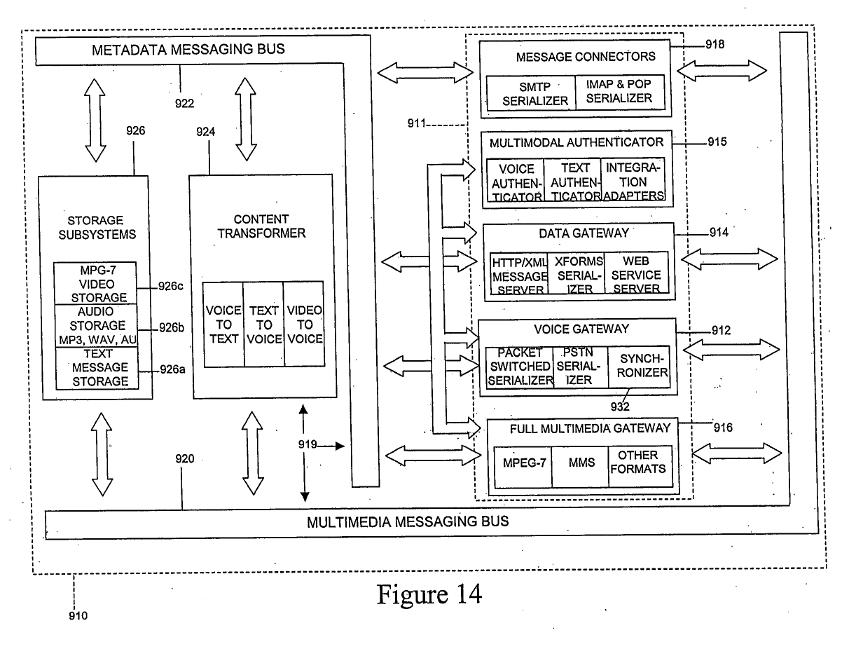

Mobile communications devices configured in accordance with the subject invention are well-suited to communicating with “omnimodal” servers, as disclosed in the pending U.S. Application Ser. No. 60/464436 filed on Apr. 22, 2003 and International Published Application No. WO 2004/095197 filed on Nov. 4, 2004, the disclosures of which are incorporated herein by reference in their entirety. Such omnimodal servers are those in which the server system architecture can handle message creation, receipt and response for any digitalizable message, in any format, via any popular messaging device, interface, or mode, that is received and delivered via any popular channel. Such server system architecture 10 is shown in overview in FIG. 14, and is designed to handle message creation, receipt, and response for any sort of digitizable message in any format, including, but not limited to, voicemail, email, short text (Short Message Service (SMS)), Multimedia Messaging Service (MMS), instant messages, and faxes, via any popular end user messaging device (phone, mobile phone, handheld computer, desktop/laptop computer, fax machine, converged devices), via any popular interface (Wireless Application Protocol (WAP) browser, voice interface, WAP/voice, SMS client, MMS client, Java client, BREW® (Binary Run-time Environment for Wireless) client, web browser, thick IM client, etc.), in any mode (text, audio, still image, moving images, or combination thereof), and received or delivered via any popular channel (Public Switched Telephone Network (PSTN), the Internet, etc.).

The omnimodal messaging system typically operates as a “core application and application infrastructure” in a communications network or networks in the multiple sender, receiver and user modes of the same or varying design and operational characteristics. The messaging architecture 910 is assembled through machine-to-machine and/or human-to-machine interfaces. This generic or universal messaging system 910, termed herein as “omnimodal”, uses a multi-media messaging server application architecture organized using a set of eight loosely-coupled subsystems. These subsystems, as detailed below, fall into three general functional groups: Interface/Connector Subsystems 911, (including the Voice User Interface Gateway 912, Data Gateway 914, Multimedia Gateway 916, and Message Connectors 918), Core Subsystems 919 (including Multimedia Messaging Bus 920, Metadata Messaging Bus 922, and Content Transformer 924), and Storage Subsystems 926.

The first four of these subsystems 912-918 are interface/connector subsystems. They all interact with the world external to the application. They support all the interfaces. They also manage connections to external telecommunications and data networks as well as to external messaging systems. They are responsible for sending and receiving any popular kind of message in any popular mode for any popular device, as detailed above.

The next three subsystems 920, 922, 924 can be thought of as the brains or core of the architecture. They extract message metadata (data about messages), including message type, format, mode of creation, address, originating device, subscriber, etc. They combine this metadata with information about the delivery and routing of the message provided by the networking infrastructure, information encapsulated in the user preferences and the user registry, as well as with instructions on how to process the message and the Metamessage itself. All these elements are contained within an element termed the “Metamessage” (Metamessage is “reflective”). The Metamessage is processed to determine what the system must do to deliver the original message; what content transformations (if any) need to be performed on the original message; what formats and interfaces will be used to deliver the original message. Original or transformed parts of the original message and/or a forerunner message may then be sent to external facing subsystems that then handle delivery.

The last set of subsystems, the Storage Subsystems 926, store all of the information used by the system, namely the messages themselves, Metamessages, subscriber preferences, registry data, etc.

The architecture 910 handles any format, and avoids any architectural commitments that rely on format commonalties. The resulting architecture can be termed “format independent.” The core subsystems reduce any message to two sets of data—the message and data about the message. The only assumption relied upon by the architecture is that all messages can be reduced to binary data. The Content Transformer 924 includes algorithms for converting message formats.

The loosely-coupled nature of the subsystems enables modifications to one subsystem to occur without necessitating modifications to the others. As times goes on and new message formats are introduced into the market, this architecture will readily accommodate these new formats. An additional layer need not be added. To handle the new format, the architecture 910 simply adds a connector or interface to the interface/connector subsystems 912-918, adds format conversion capability to the Content Transformer 924, and adds any relevant compression technology to the storage subsystem 926. The architecture itself need not change. “Loosely coupled” as used herein means that while the subsystems are operatively interconnected, they operate generally independently. For example, the content transformer operates asynchronously on message content as presented via the buses 920 and 922. Also, a Metamessage is created and delivered on the bus 922 independently of the associated multi-media message content carried on the bus 920. In the preferred form, the buses 920 and 922 are software buses, not hard wire buses, or the like.

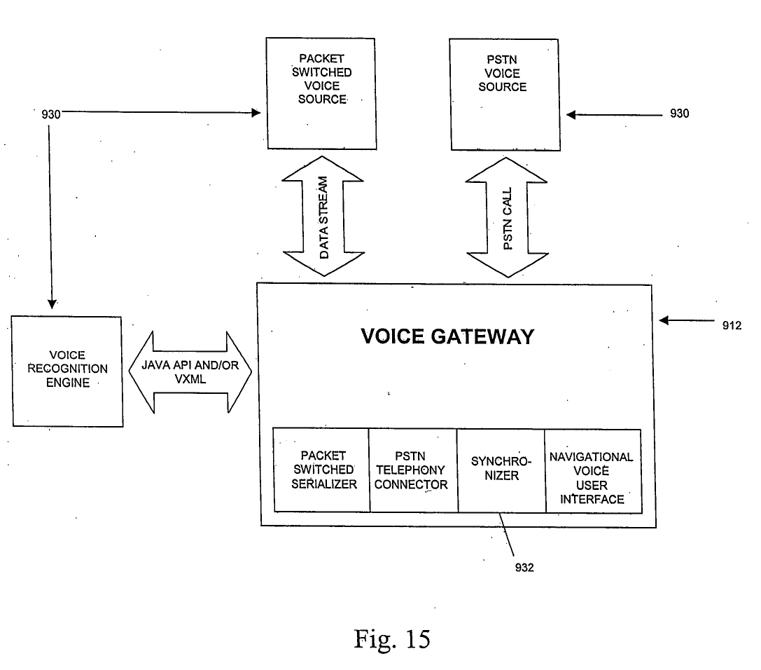

As shown in FIG. 15, this subsystem 912 enables reception of any type of voice message through voice-specific channels 930 such as PSTN, IP telephony, packet-switched telephony, and other cellular telephony of which three representative channels are illustrated. The Voice Gateway 912 is an entry point that accommodates all of the different methods of connecting to the voice user interface, and makes all voice related interactions with the system appear the same to the rest of the system. The Voice Gateway 912 enables the other components of the system to treat voice without the concern for how the voice was obtained, or what format it is in. The Voice Gateway 912 itself is rendered with standards-compliant VoiceXML, thereby adhering to the Extensible Markup Language (XML) mandate of the architecture. The Voice Gateway 912 includes functionality that enables it to synchronize multi-part messages that have one or more types of content. Since the Voice Gateway 912 is only designed to handle the voice portion of the content, through any voice channel, it will use a synchronization mechanism 932 (SMIL—Synchronized Multimedia Integration Language—compliant) to work with the Data Gateway 914, the Multimedia Messaging Bus 920, and other components in the system 910.

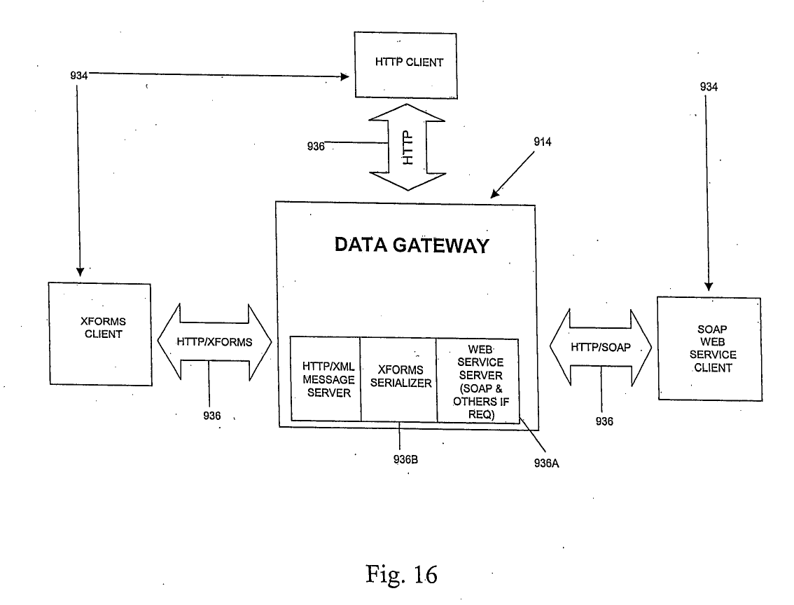

Much of the interaction between outside systems 934 (shown in FIG. 16 as three representative such systems 934) and the system 910 is done through the Data Gateway 914. The Data Gateway 914 also handles connections for subscribers. The specific subscriber interfaces are rendered, by proxy, through the Content Transformer 924 and then sent out through the Data Gateway 914. The Data Gateway enables reception of any type of data message through data specific channels 936 such as HTTP/XML, W-HTTP, i-mode, and BREW. The data gateway 914 offers access to the system 910 through various web service types including Simple Object Access Protocol (SOAP) 936a and Xforns 936b. SOAP 936a allows external applications to communicate with the data gateway independent of the computer platform. SOAP 936a can be thought of as an XML schema for remote procedure calls, like message retrieval. XForms enables rendering of generic interfaces. XForms interfaces can be transformed to specific user interface types at the node. In this way carriers can render proprietary subscriber interfaces that have pre-built interaction sets with the application. As a result, mobile carriers will be able to create their own subscriber interfaces in a more flexible and less costly way by simply creating one set of Extensible Stylesheet Language Transformations (XSLTs). Whereas a simple XML interface requires the customer to create workflow code, XForms streamlines this process by eliminating that requirement. XForms 936b is a World Wide Web Consortium (W3C) standard. By providing these two distinct types of web service interfaces (SOAP and XForms), the application optimizes connectivity options for users of the architecture 910. The end result is an application that is more flexible and less costly to deploy than anything now available.

The subsystem 916 serves the same general function as the Data Gateway 914, but is designed to receive/send any type of multimedia file or message format such as MMS, Moving Picture Experts Group (MPEG), MPEG-4, MPEG-7, FLIC, Audio Visual Interleaved (AVI), QuickTime Movie (MOV), Artificially Structured Films (ASF), Macromedia Flash, etc.

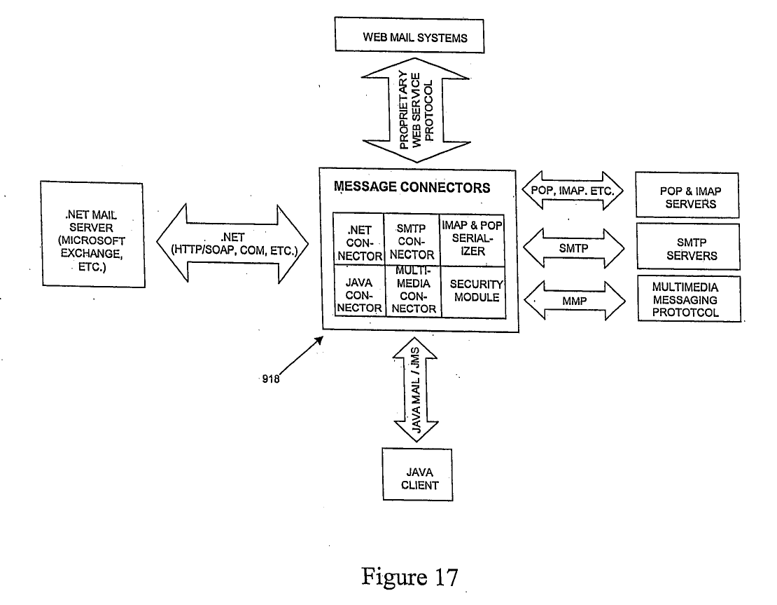

The subsystem 918 shown in FIG. 17 is designed to connect with external messaging systems such as Simple Mail Transfer Protocol (SMTP), Post Office Protocol (POP), Internet Messaging Access Protocol (IMAP), Short Message Service Center (SMSC), and Multimedia Messaging Service Center (MMSC). This subsystem is able to exchange messages with other messaging systems outside of the system 910, as well as with the Multimedia Messaging Bus 920 and Metadata Messaging Bus 922.

The Multimedia Messaging Bus 920 allows different types of media to be put in a queue and then processed. It solves several different requirements. First, it allows coordinated access to all of the contents of the message (regardless of what type of content is inside the message) by different processing subsystems (Content Transformer 924, Storage Subsystem 926, etc.). Second, it provides this access in a scalable and asynchronous manner. As a result spikes in message traffic do not cause the system 910 to halt. Finally, it permits the content of the message to be retrieved at run-time while the information about the message (on the Metadata Messaging Bus 922) is replicated to all of the different nodes on a distributed network.

The Metadata Messaging Bus 922 transports Metamessages (as defmed above) between subsystems, so subsystems can coordinate to process messages. In order to provide a decoupling between messages and information about the messages, the Metadata Messaging Bus 922 creates Metamessages that contain data about the original messages. The Metamessages are themselves provided as messages on a queue. This enables the clients of the Multimedia Message Bus 922 to know needed information about the messages prior to actually processing the messages. This approach provides tunable performance and scalability.

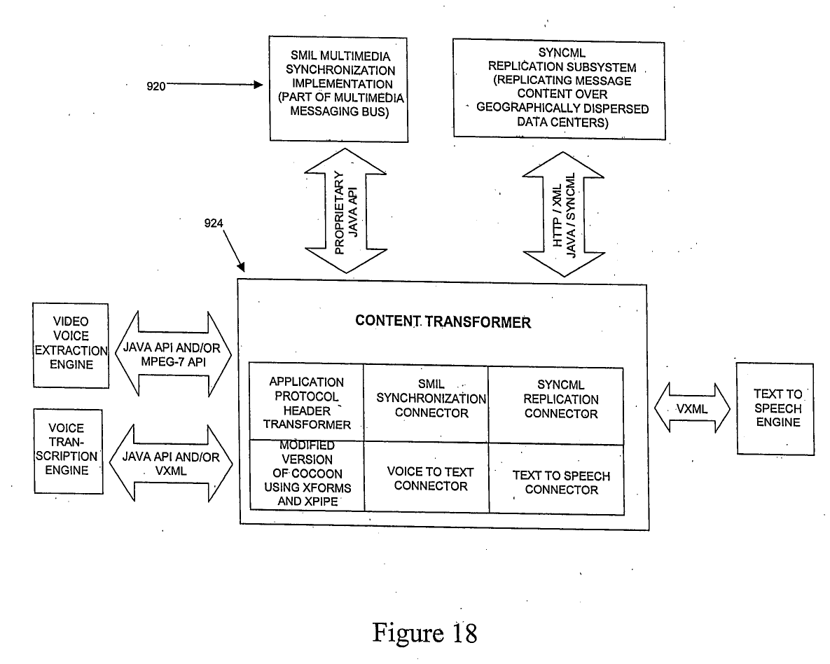

The subsystem 924 shown in detail in FIG. 18 transforms any popular message format into any other popular message format to facilitate message creation and delivery via any popular format, interface, device, mode, or channel. In one form of the server system that is more easily implemented, content transformation is done asynchronously, that is, on a deferred basis. This approach lessens the performance and scalability requirements inherent to synchronous systems. Transformation appears to be synchronous to the extent that processing resources are available. In other words, while the server system in its present preferred form operates asynchronously, that asynchronous operation can appear to be synchronous, e.g., if there is no queuing on the buses 920 and 922.

Transformable content includes any combination of text, still images, audio, and moving images. Because messages may include any combination of these content modes, the total number of combinations is twenty-four on both the sending and receiving side. These modes each contain multiple formats that must be supported.

The set of subsystems 926 handles storage of the various content pieces of stored messages. The messages and parts of messages, whether text, still images, audio, and/or moving images, must be stored. These subsystems will be comprised of several off the shelf components amongst which the most important are:

Text Message Storage: The database 926a will be used to store the message metadata to facilitate searches, queries, and data mining. The database 926a may also be used to store the text portion of messages.

File Storage: The multimedia or voice files are stored in their native format in a file storage systems 926c and 926b, respectively, and then be processed by the Content Transformer 924 to be played back to the user. The Content Transformer 924 can also write back to the Storage Subsystems 926 to use them as a caching mechanism, or to provide different types of file formats. There are a variety of file formats each of which may require a particular type of storage as the system scales. Several standard compression methods are used to facilitate storage of various formats. The Storage Subsystems 926a-c as shown are also designed to support streaming delivery of messages to recipients.

LDAP: A Lightweight Directory Access Protocol (LDAP) implementation is used with storage subsystem 926 to find the location of the stored files. LDAP is a set of protocols based on standards within the X.500 standard, but simplified, and allows any type of Internet access. It runs almost any application and is compatible with all popular computer platforms. Java Naming and Directory Interface (JNDI) interfaces are provided to facilitate fail-over capabilities.

The subsystems 926 can be considered as a single storage subsystem with sub-subsystems associated with various message types, and one or more sub-subsystem for message management and retrieval.

While the omnimodal server has been described with respect to its preferred embodiments, it will be understood that other numbers of subsystems can be used intercommunicating through other bus architectures besides two parallel buses that open multi-media messages and Metamessages.

One or more digital data processing devices can be used in connection with various embodiments of the invention. Such a device generally can be a personal computer, computer workstation, laptop computer, server computer, mainframe computer, handheld device (e.g., personal digital assistants, handheld computers, smart phones, and cellular telephones),.information appliance, or any other type of generic or special-purpose, processor-controlled device capable of receiving, processing, displaying, and/or transmitting digital data.

A processor generally is logic circuitry that responds to and processes instructions that drive a digital data processing device and can include, without limitation, a central processing unit, an arithmetic logic unit, an application specific integrated circuit, a task engine, and/or any combinations, arrangements, or multiples thereof. Software, programs, or code generally refers to computer instructions which, when executed on one or more digital data processing devices, cause interactions with operating parameters, sequence data/parameters, database entries, network connection parameters/data, variables, constants, software libraries, and/or any other elements needed for the proper execution of the instructions, within an execution environment in memory of the digital data processing device(s). Those of ordinary skill will recognize that the software and various processes discussed herein are merely exemplary of the functionality performed by the disclosed technology and thus such processes and/or their equivalents may be implemented in commercial embodiments in various combinations and quantities without materially affecting the operation of the disclosed technology.

As is known to those of ordinary skill, a network can be a series of network nodes (each node being a digital data processing device, for example) that can be interconnected by network devices and communication lines (e.g., public carrier lines, private lines, satellite lines, etc.) that enable the network nodes to communicate. The transfer of data (e.g., messages) between network nodes can be facilitated by network devices such as routers, switches, multiplexers, bridges, gateways, etc. that can manipulate and/or route data from an originating node to a destination node regardless of any dissimilarities in the network topology (e.g., bus, star, token ring, etc.), spatial distance (local, metropolitan, wide area network, etc.), transmission technology (e.g., TCP/IP, HTTP, etc.), data type (e.g., data, voice, video, multimedia, etc.), nature of connection (e.g., switched, non-switched, dial-up, dedicated, virtual, etc.), and/or physical link (e.g., optical fiber, coaxial cable, twisted pair, wireless, etc.) between the originating and destination network nodes.

The invention has been mainly described as operating wholly on a data network using the standard HTTP. This has the advantage that a phone call is not required to initiate communications, thereby avoiding the charges associated with that action. Further, use of a data network, rather than a telephone network, allows for the network connection to remain continuously available as long as the mobile communications device is functionally connected to the network. Additionally, unlike many messaging systems that allow voice and text messages, the ability to conduct communications wholly over a data channel eliminates the need to simultaneously use a phone line and a data channel in parallel, a potentially expensive option. The use of data channels also beneficially and effectively increases the overall speed of the process as compared to prior art device and systems, in particular those devices and systems in which the server performs the processing operations and communicates the results to a mobile device. The present invention, however, is not limited to data networks or networks using HTTP. The present invention is usable or adaptable for use with other networks, the other network types being known to those skilled in the art and including, but not limited to: public switched telephone networks (PSTN), mobile telephone networks either with or without 1×Radio Transmission Technology (1×RTT) networks, 1×RTT “evolution data only” (EVDO) networks, Global System for Mobile Communications (GSM) networks, General Packet Radio Service (GPRS) networks, GSM “Enhanced Data GSM Environment” (GSM EDGE) networks, Code-Division Multiple Access (CDMA) networks, Wideband CDMA (WCDMA) networks, CDMA2000 networks, 802.11 networking (i.e., “WiFi”), and public data networks such as the Internet.

Several of the flow charts herein illustrate the structure or the logic of the present invention as embodied in computer program software for execution on a computer, digital processor, microprocessor, mobile communications device, or server. Those skilled in the art will appreciate that the flow charts illustrate the structures of the computer program code elements, including logic circuits on an integrated circuit, that function according to the present invention. As such, the present invention is practiced in its essential embodiment(s) by a machine component that renders the program code elements in a form that instructs a digital processing apparatus (e.g., mobile phone) to perform a sequence of function step(s) corresponding to those shown in the flow diagrams.

It will be appreciated by those of ordinary skill in the pertinent art that the functions of several elements may, in alternative embodiments, be carried out by fewer, or a single element. Similarly, in some embodiments, any functional element may perform fewer, or different, operations than those described with respect to the illustrated embodiment. Also, functional elements (e.g., modules, databases, interfaces, computers, servers and the like) described as distinct for purposes of illustration may be incorporated within other functional elements in a particular implementation.

Unless otherwise specified, the illustrated embodiments can be understood as providing exemplary features of varying detail of certain embodiments, and therefore, unless otherwise specified, features, components, modules, elements, and/or aspects of the illustrations can be otherwise combined, interconnected, sequenced, separated, interchanged, positioned, and/or rearranged without materially departing from the disclosed systems or methods. Additionally, the shapes and sizes of components are also exemplary and unless otherwise specified, can be altered without materially affecting or limiting the disclosed technology.

While the invention has been described with respect to preferred embodiments, those skilled in the art will readily appreciate that various changes and/or modifications can be made to the invention without departing from the spirit or scope of the invention as defined by the appended claims.

1. A mobile communications device for communicating with a server over a network, the device comprising:
a visual interface device that displays data;
an audio interface device that receives acoustic input and converts the acoustic input to data;
a network connection;
a memory containing an applications program;
a processor operably coupled to the visual interface device, the audio interface device, and the memory, wherein the applications program is executed on the processor; and
wherein the applications program includes instructions and criteria to locally generate graphical user interfaces so as to be displayed on the visual interface, to control the input of data via the audio interface, the transmission of such data over the network to the server such that the data are accessible to a recipient, and the retrieval of electronic messages from a server.

2. The device as recited in claim 1, further comprising a tactile interface device that is operably coupled to the processor by which a user can navigate the data being displayed on the visual interface.

3. The device as recited in claim 1, wherein the network connection is adapted and configured to connect to a data network and the applications program includes instructions and criteria so as to transmit and receive such data wholly over a data network.

4. The device as recited in claim 2, wherein the applications program includes instructions and criteria to display data with the visual interface device and to navigate data using the tactile interface device.

5. The device as recited in claim 4, wherein the applications program includes instructions and criteria for retrieving and visually reviewing a listing of electronic mail messages with the visual interface device, selecting a specific user-specified electronic mail message from the list to visualize with the visual interface device, and creating a spoken response to the electronic mail message with the audio interface device for transmission and subsequent access and review via an electronic mail account.

6. The device as recited in claim 1, wherein the audio interface device receives data and converts the data to acoustic output.

7. The device as recited in claim 6, wherein the data converted from the acoustic input is stored in the memory to be audibly reviewed by a user with the audio interface device before being transmitted over the network.

8. The device as recited in claim 6, wherein the applications program includes instructions and criteria for receiving data representing audio messages from a server and for playing the received data via the audio interface device.

9. The device as recited in claim 8, wherein the applications program includes instructions and criteria to receive and decode base64 encoded audio messages.

10. The device as recited in claim 4, wherein the applications program includes instructions and criteria to request and receive data from the server, which can be rendered audibly with the audio interface device.

11. The device as recited in claim 1, wherein the tactile interface device allows for textual input that can be transmitted over the network.

12. The device as recited in claim 1, wherein the applications program is downloaded to the device via an over-the-air distribution network.

13. A multimedia messaging system for communicating with a server, the server having an architecture including interface/connector subsystems that receive, process, and deliver messages that include metadata and whose content can be of different types delivered to and from devices and computer platforms of different types, over different channels, using different protocols and interfaces, the system comprising:
a mobile communication device operationally coupled to the server; said mobile communication device including:
a visual interface device that displays data;
an audio interface device that receives acoustic input and converts the acoustic input to data;
a network connection;
a memory containing an applications program;
a processor operably coupled to the visual interface device, the audio interface device, and the memory, wherein the applications program is executed on the processor; and
wherein the applications program includes instruction and criteria for locally generating graphical user interfaces and displaying same with the visual interface and controlling the input of data via the audio interface and the transmission of such data over the network to the server such that the data or instructions for data access are accessible to a recipient via a text-based application.

14. A computer readable medium whose contents cause a mobile communications device to perform messaging with a remote communications device, the mobile communications device having an audio interface for converting an acoustic input to data representing the acoustic input and for converting data to acoustic output and the remote communications device having an applications program with functions for messaging, the contents of said computer readable medium including instructions, criteria and code segments for:
generating graphical user interfaces in the mobile communications device by accessing instructions stored locally in the mobile communications device;
storing locally in the mobile communications device data converted from acoustic input with the audio interface; and
transmitting the data representing acoustic input to a remote communications device via a data network such that the data or instructions for data access are accessible to a recipient via a text-based application.

15. The computer readable medium as recited in claim 14, wherein the contents of said computer readable medium further includes instructions, criteria and code segments for:
receiving data by communicating with a remote communications device via a network; and
visualizing data with a graphical user interface of the mobile communications device.

16. The computer readable medium as recited in claim 14, wherein said transmitting and receiving data are conducted via a data network.

17. The computer readable medium as recited in claim 14, wherein the contents of said computer readable medium further includes instructions, criteria and code segments for: converting data to acoustic output via the audio interface.

18. The computer readable medium as recited in claim 14, wherein the contents of said computer readable medium further includes instructions, criteria and code segments for:
retrieving electronic mail messages;
visually reviewing a listing of electronic mail messages with the graphical user interface;
selecting a specific electronic mail message from the list to visualize; and
creating a spoken response to the electronic mail message with the audio interface for transmission and subsequent access and review via an electronic mail account.

19. The computer readable medium as recited in claim 14, wherein the contents of said computer readable medium further includes instructions, criteria and code segments for:
receiving from the remote communications device data representing audio messages; and
audibly rendering the audio messages via the audio interface.

20. The computer readable medium as recited in claim 14, wherein the contents of said computer readable medium further includes instructions, criteria and code segments for:
storing in the memory of the mobile communications device binary data representing acoustic input; and
transmitting the binary data to a uniform resource locator supplied by the remote communications device.

21. The computer readable medium as recited in claim 14, wherein the contents of said computer readable medium further includes instructions, criteria and code segments for:
receiving data from the remote communications device, the data including a portion representing a voice message and information that allows the data representing the voice message to be distinguished from other data; and
processing the data representing the voice message separately from other data.
